(19) United States
(12) Patent Application Publication
(10) Pub. No.: US 2017/0314273 A1
(43) Pub. Date: Nov. 2, 2017

(54) SYSTEM AND METHOD FOR APPLYING ABRASION AND WEATHER RESISTANT COATING TO PROFILES

(71) Applicant: Palram Industries (1990) Ltd., Kibbutz Ramat Yohanan (IL)

(72) Inventors: REUVEN HUGI, Nahariya (IL); Biata STEPOVOY, Kiryat Bialik (IL); Irena MICHEDO, Haifa (IL)

(21) Appl. No.: 15/520,560

(22) PCT Filed: Sep. 3, 2015
(86) PCT No.: PCT/IL2015/050885

§ 371 Date: Apr. 20, 2017

Related U.S. Application Data
(60) Provisional application No. 62/045,604, filed on Sep. 4, 2014.

(51) Int. Cl. E04F 15/10; E04B 1/00; B44C 5/04; E04F 15/02; B05D 3/06

(52) U.S. Cl. CPC E04F 15/107; E04F 15/02183; B05D 3/067; B44C 5/04; E04B 1/003

(57) ABSTRACT

Embodiments of the invention are related to synthetic printed boards and a method of printing and coating the synthetic boards. A synthetic board is printed, using for example, an inkjet printer, to form a pattern on at least one face of the board. The printed pattern is then cured. The printed pattern is coated with a transparent protective coating. The transparent protective coating has a thickness of less than 500 microns. The transparent protective coating is further cured to be hardened and weather-durable.

### BACKGROUND OF THE INVENTION

Decorative synthetic decks, assembled as floors in gardens and balconies became extremely popular among clients and designers in recent years. Decorative synthetic decks are more durable and have much lower maintenance costs (i.e., no polishing, re-painting or waxing is needed) than timber (wooden) decks. Furthermore, decorative synthetic decks are not limited to a certain wooden appearance and can be designed according to any desire of the client or the designer to have almost any color or pattern.

Synthetic decks are usually assembled from PVC foam boards that are coextruded with an additional layer. The coating includes compounds and components that improve the boards' wear resistance, environmental resistance and impact resistance. The coating further includes matting agents to form the desired pattern and color pigments to color the board. However, the currently known coating has limited environmental durability and has a thickness of 500-800 μm that is approximately 35% of the boards' total price. Formation of the pattern on the deck's boards envelope (e.g., the outer surface of the deck) is done by inclusion of the desired color into the coating (e.g., a cap layer) material and embossment of the texture during an extrusion process of the boards by applying pressure on the surface of the board with an embossment roll. Changing the pattern or the coloring of boards in the production line is complicated, because it requires stopping the extrusion process, cleaning the extrusion line and replacing the coating material with a new one. Reproduction of deck's boards with pattern is complicated and an exact reproduction of a previously formed pattern is almost impossible.

### SUMMARY

Some aspects of the invention may be related to a method of coating synthetic deck boards. The method may include printing a pattern on top of a pre-prepared deck board and curing the pattern. In some embodiments, the method may further include applying a transparent protective coating on top of the cured pattern, wherein the thickness of the transparent protective coating is less than 500 microns and curing the transparent protective coating.

Some additional aspects of the invention may be related to synthetic printed boards, for example, decorative synthetic boards. Each printed board may include a synthetic board, a printed pattern printed directly on the synthetic board having a printed resolution of at least 180 dpi and a transparent protective coating.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of an exemplary system for coating synthetic deck boards according to some embodiments of the invention;

FIG. 2 is an illustration of an exemplary schematic illustration of layers in a printed board according to some embodiments of the invention;

FIG. 3 is a flowchart of a method of coating synthetic boards according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Some aspects of the present invention may be related to a system and a method of coating synthetic boards or girders (hereinafter board). Synthetic boards may possess both decorative and functional improved properties in comparison to timber board. According to some embodiments of the invention improved decorative properties may be achieved by printing a printed pattern on top of the synthetic board. The pattern may be printed by an inkjet printer at a relatively high resolution. The printing may further allow high versatility in choosing the pattern to be printed. Practically speaking, a consumer may choose or select any desirable image to be printed on the boards. For example, the costumer may choose a traditional timber-like appearance, an image of pebbles, grass, flowers, or even a photograph taken by a camera (e.g., a camera associated with the client). The high versatility may allow producing large variety of printed patterns in a single production process. Therefore, the client may order several different boards printed with different patterns at the same order.

According to some embodiments of the invention improved functional properties of the boards may include improving the durability and simplifying the maintenance of the deck made from the boards. The improvement may be achieved by applying a protective transparent coating to cover the printed pattern. The coating may include abrasive and UV radiation resistance components.

A synthetic board (e.g., a deck board) may be sprayed with a base layer that includes, for example, acrylic component used as a reactive monomer in energy curable coatings. The base layer may be cured using ultraviolet (UV) radiation or any other suitable method. A pattern having any desirable printable design (as to colors and forms) may be printed using, for example, inkjet printer, on top of the base layer. The pattern may then be cured by UV radiation. Additional transparent protective coating layer may be applied on top of the cured pattern in order to protect the synthetic board and its underlying layers from harmful environmental effects, such as harmful UV radiation and wear. The resistance to UV radiation may be measured as a resistance for QUV-B radiation radiated for 2500 hours by accelerated weathering machine according to American Society for Testing Materials (ASTM) G-154. Additionally or alternatively the resistance to UV radiation may be measured by exposure to Xenon machine for 1000 hours according to ISO 4892-2. The xenon machine may include 340 nm lamps radiating 0.51 W/m2/nm. In some embodiments, the thickness of the protective coating may be less than 150 μm, for example, 100 μm. The transparent protective coating layer may be cured using, for example, UV radiation.

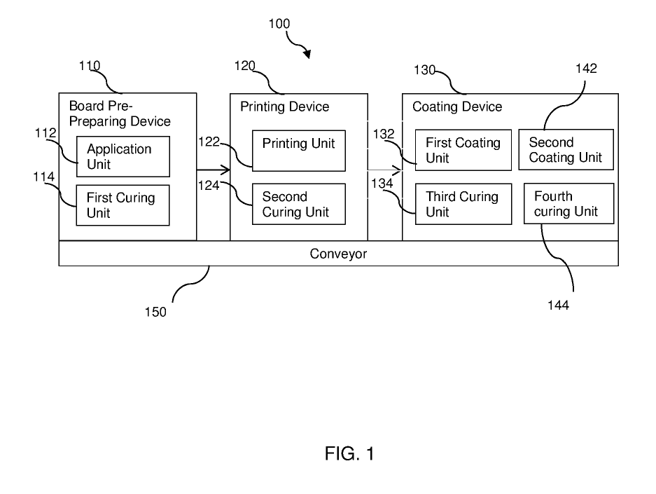

Reference is made to FIG. 1 which is a high level block diagram of an exemplary system 100 for coating synthetic boards (e.g., deck boards) according to some embodiments of the invention. Coating system 100 may include a board pre-preparation device 110 for pre-preparing the synthetic boards (e.g., by applying a base layer on at least some sides of a synthetic board), a printing device 120 for printing a patterned layer on top on desired sides of the board and a coating device 130 for applying a transparent protective coating layer on top of the underlying layers on at least some of the sides of the board. In some embodiments, system 100 may include a conveyor 150 for conveying the synthetic boards through the various application devices.

Board pre-preparation device 110 may include an application unit 112 for applying the base layer material over the surfaces of the synthetic board and a first curing unit 114 for curing the base layer. Application unit 112 may include any system that is configured to apply, deposit, coat, etc. base material over the surface of a synthetic board. For example, unit 112 may be a spraying system. First curing system 114 may include any system that is configured to cure polymeric base material, for example, a system that includes ultraviolet (UV) radiation source or sources, such as a mercury lamp or a UV light emitting diode (LED).

Printing device 120 may include a printing unit 122 for printing a pattern on top of at least some of the sides of a pre-prepared board and a second curing unit 124 for curing the pattern layer. According to some embodiments printing unit 122 may be an inkjet printer for printing patterns on top of the base layer on selected surfaces of the pre-prepared board. The use of inkjet printers may allow printing virtually any desired pattern at any color or combination of colors on the selected surface of the board and to easily change the printed pattern from board to board. The pattern to be printed on the board may be received from digital image file or similar file (e.g., a file stored in a memory associated with printing unit 132). This may provide enhanced flexibility to clients and designers in satisfying their needs. It may allow reprinting on a board at a high accuracy and repeatability of any pattern that was previously printed, even after a long period of time, with minimal or none dependency on the passing time. For example, a client, that wants to replace one or more boards in an already assembled unit, may do so by ordering and receiving newly manufactured boards with substantially the same appearance, even years after the original purchase. In some embodiments, the newly ordered boards may be slightly modified to match the remaining (assembled) boards that may have a slight difference in appearance compared with the original appearance due to weathering effects.

Second curing unit 124 may include any system that may be configured to cure pattern, for example, a system that includes ultraviolet (UV) radiation source(s), such as a mercury lamp or a UV light emitting diode (LED).

Coating device 130 for applying a transparent protective coating layer on top of the cured pattern may include a first coating unit 132 for applying, depositing, coating, etc. a first transparent protective coating layer, and a third curing unit 134 for curing the first transparent protective coating layer. Coating unit 132 may include any system that is configured to apply, deposit, coat, spray, smear, etc. transparent protective coating material over at least one face (e.g., at least one side of the outer surface or envelop) of the board. For example, unit 132 may be a spraying system. Coating unit 132 may be configured to apply a layer with thickness of no more than 500 microns, for example, no more than 400 μm, no more than 250 μm, or 150 μm or less. Third curing unit 134 may include any system that may be configured to cure transparent protective coating material, for example, a system that includes ultraviolet (UV) radiation source, such as a mercury lamp or a UV light emitting diode (LED).

In some embodiments, coating device 130 may further include a second coating unit 142 and a fourth curing unit 144 for applying a second transparent protective coating layer on top of the first transparent protective coating layer. The second transparent protective coating layer may include substantially the same composition as the first transparent protective coating layer or may include different composition(s). Second coating unit 142 may include any system that is configured to apply, deposit, coat, spray, smear, etc. a protective coating layer over the surface of a board, for example, unit 142 may be a spraying system. Second coating unit 142 may be configured to apply a layer with thickness no more than 75 μm. Fourth curing system 144 may include any system that may be configured to cure a transparent protective coating material, for example, a system that includes ultraviolet (UV) radiation source, such as a mercury lamp or a UV light emitting diode (LED).

In some embodiments, the total thickness of the protective coating layer applied on top of the pattern may not exceed 150 μm and may be, for example, 100 μm. In some embodiments, the protective coating layer may be applied by a single application device (e.g., unit 130), for example, such that a single coating layer having a thickness of 100 μm or less may be sprayed on top of the surface of the board after the pattern has been disposed, using for example, a lacquer based on photosensitive urethane acrylate resin, acrylic monomer, catalyst and stabilizer. In some embodiments, two protective coating layers may be applied using one or two coating units (e.g., units 132 and 142), such that the total thickness of both coating layers may not exceed 500 μm. For example, a first coating layer that includes a lacquer based on urethane acrylate resin may be applied or disposed by first coating unit 132, reaching thickness of, for example, 100 μm or less. The first coating layer may be cured by third curing system 134. A second coating layer may be applied on top of the first cured coating layer. The second coating layer may include a lacquer based on urethane acrylate resin or any other suitable lacquer. The second coating layer may be applied using first coating unit 132 or second coating unit 142 reaching thickness of, for example, 150 μm or less. The second coating layer may further be cured by curing system 134 or curing system 144 as the case may be.

In some embodiments, system 100 may include conveyor 150 for conveying synthetic boards from one application device to another. Conveyor 150 may include a conveyor belt or any other conveying mechanism configured to convey boards from one station to the other and allowing application of the respective coating layers on all desired surfaces of the board. In some embodiments, at least some of devices 110-130 and conveyor 150 may be controlled by a controller (not illustrated). The controller may include a memory that includes software code or instructions for controlling the various aspects of the synthetic boards coating process, according to some embodiments of the invention. For example, the software code may include instructions regarding the thickness of each of the protective coating layers to be applied by device 130, the pattern and the colors to be applied by printing device 120, the amount and duration of UV radiation to be applied by each of the curing units, and the like. The controller may further include a processor for executing the code, Input/Output (I/O) units to enable man-machine interface, loading of programs and monitoring the operation of the device.

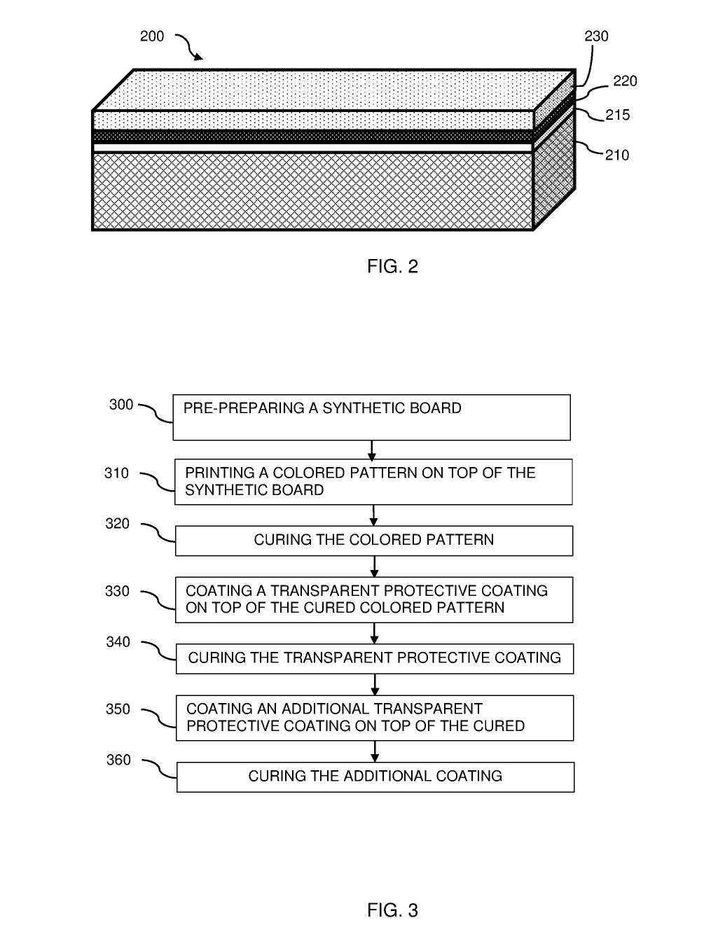

Reference is made to FIG. 2 which illustrates an exemplary schematic description of layers in a decorative synthetic printed board according to some embodiments of the invention. Synthetic printed board 200 may include a synthetic board 210, pattern layer 220 and protective coating layer 230. Synthetic board 210 may include any suitable synthetic material for making boards, for example, a foamed polyvinylchloride (PVC), polypropylene, polyethylene, wood polymer composite (WPC) or the like. As used herein a synthetic material may be any manmade material, for example, manmade material that includes polymers (e.g., bulk polymers and/or composite materials). The dimensions of exemplary synthetic board 210 for decorative decks may be: a length of 1000-6000 mm, a width of 140 mm and a thickness of 25 mm Synthetic board 210 may be fabricated from polymers having a variety of colors, for example, brown, grey or white. It would be apparent that other dimensions of synthetic board 200 may be treated depending on the dimensions a coating system, such as coating system 100 of FIG. 1.

Synthetic board 210 may further be coated with a base layer 215 that may include any material suitable for forming a base layer for printing a pattern layer, while having good adhesion to the synthetic board. As used herein, good adhesion between a layer and a substrate is defined by the ability of the layer to stay in contact with the substrate during a long use period of the coated substrate. For example, the base layer may stay in contact with the synthetic board during the service time of the deck, e.g., during at least 25 years of washing of the deck, walking on the deck, exposure of the deck to weather strenuous, etc. Base layer 215 may include a primer layer to enhance the adhesion between the printed pattern and the synthetic board. Additionally base layer 215 may include a white layer (or any other light color layer) to form a good visual base for printing pattern. Adding a white layer may be required, for example, when the synthetic board is manufactured from grey or brown PVC. An exemplary base material may include: acrylic additive that is used as a reactive monomer in energy curable coatings. The base layer may have a thickness of no more than 40 μm.

Pattern 220 may be printed on top of base layer 210 using an inkjet printing system. Pattern 220 may be printed at a resolution of at least 180 dpi. Pattern 220 may include at least one color. The color may be made from known pigments. Pattern 220 may be printed according to a predetermined pattern, selectable by the client. The client may select a desired pattern from a variety of patterns stored as digital image files in a database at a service station selling the deck-boards. Alternatively, the client may provide a digital image file that includes the desired pattern to be printed on the synthetic printed board. In some embodiments printed pattern 220 may include two or more colors. Alternatively, printed pattern 220 may include only one color (e.g., black) to be printed on based layer 215 (e.g., a white base layer) to form for example, a black and white pattern having a resolution of at least 180 dpi.

For example, pattern 220 may include a wood-like texture that may give the impression that the synthetic deck is a wooden deck. Alternatively, the pattern can be other than a wood-like texture, using various colors like blue, green, pink, grey and the like. In yet another example, the pattern may include a stone-like texture (e.g., pebbles), making the impression that the synthetic deck is made of stone tiles. The pattern layer may have a thickness of no more than 20 μm, for example, 10-8 μm.

Protective transparent coating layer 230 may include any material or lacquer that may provide protection to the printed board from harmful environment effects. Coating layer 230 may include a lacquer based on urethane acrylate resin or the like. Coating layer 230 may have a thickness of no more than 500 μm, for example, 400-100 μm. In some embodiments, coating layer 230 may include, or be applied as two coating layers, a first protective coating layer and a second protective coating layer, such that total thickness of both coating layers is not higher than 500 μm, 250 μm, 100 μm or less. In some embodiments both coating layers may include the same lacquer, for example, a lacquer based on urethane acrylate resin. Alternatively, the two coating layers may include different lacquers. For example, a first coating layer may include a first lacquer that may have a thickness of, for example, 50 μm and a second coating layer that includes a second lacquer may have a thickness of, for example 40 μm. In some embodiments, having two or more coating layers (e.g., three coating layers, four coating layers, etc.) may allow to coat synthetic boards with a thicker coating layer or to provide better durability. For example, if the external coating layer, of the two or more coating layers, is damaged the other layers may still protect the synthetic board.

Transparent protective coating layer 230 may protect the printed synthetic board from harmful UV radiation such as sun radiation. Coating layer 230 may have a UV protection level required according to ASTM G-154, when the coating is exposed to 2500 hours of QUV-B by an accelerated weathering machine. Transparent protective coating layer 230 may further provide an improved abrasion resistance and scratch resistance.

The scratch resistance may have resistance to scratch of at least 2 kg at 0.3 m/min. Table 1 summarizes scratch resistance results that were obtained during an examination of five (5) coated boards produced according to some embodiments of the invention in comparison to a non-coated board. The samples were scratched using tip that was loaded with 0.5-2.5 kg and moved at 0.3 m/min in both the longitudinal and the transversal direction of each board's face. The boards were coated with urethane acrylate based coating and cured using various UV radiation sources at various wavelengths. The values included in the table are the loads at which the scratches were observed.

TABLE 1

| | LED curing | transversal | longitudinal |
|---|---|---|---|
| Sample | devise | (kg) | (kg) |
| Coated and printed board | 365 nm (4 W/cm²) | 2.5 | 2.0 |
| Coated and printed board | 395 nm(16 W/cm²) | Not seen | 2.5 |
| Coated and printed board | 395 + 365 nm | 2.5 | 2.0 |
| Coated and printed board | 365 + 395 nm | 2.0 | 1.5 |
| Coated and printed board | UV( F600S) | 2.0 | 2.0 |
| Uncoated board | Uncoated sample | 0.5 | 0.5 |

As can be seen the uncoated board has inferior scratch resistance and scratches are observed already in test with loading of 0.5 Kg, in comparison to the printed and coated samples in which at least 1.5-2.5 Kg are needed to obtain observed scratches on the boards.

In an additional scratch resistance test done on coated and printed board in comparison to an uncoated board even better results were obtained. The samples were scratched using tip that was loaded with 0.5-5 kg and moved at 0.3 m/min in both the longitudinal and the transversal direction of each board's face. The boards were coated with urethane acrylate based coating and cured using various UV radiation sources at various wavelengths.

Table 2 summarizes scratch resistance results of the second test.

TABLE 2

| | UV curing | transversal | longitudinal |
|---|---|---|---|
| Sample | devise | (kg) | (kg) |
| Coated and printed board | 240-420 nm | 5.0 | 4.0 |
| Uncoated board | Uncoated sample | 0.5 | 0.5 |

The coated and printed board has a superior behavior that of at least 4 kg are needed to obtain observed scratches on the boards.

Reference is now made to FIG. 3 that depicts a flowchart of a method of coating synthetic boards (e.g., board 210) according to some embodiments of the invention. The method of FIG. 3 may be performed by system 100 or by other suitable material deposition system that is adapted to perform the method similarly to system 100. In box 300, the method may include pre-preparing the synthetic board. The pre-preparing stage may include cleaning a synthetic board, for example, PVC board, polypropylene board, polyethylene board and a wood polymer composite (WPC) board. The pre-preparing stage may further include applying a base layer on top of at least one surface of the synthetic board. In some embodiments, applying the base layer may include spraying the base layer over the surface of the board, using for example, unit 112.

The base layer may include a primer layer to enhance the adhesion of a printed pattern to the synthetic board. In some embodiments, the base layer may include a primer layer and white base color. An exemplary base layer may include an acrylic additive that is used as a reactive monomer in an energy curable coatings material. The pre-preparing stage may further include curing the base layer. The base layer may be cured using UV radiation, for example, by curing system 114. For example, for base material having the acrylic additive that is used as a reactive monomer in energy curable coatings, curing is by using UV radiation having 360-420 nm wavelength at at least 2 W/cm² intensity for at least 1 minute, when the board is being conveyed at a speed of 1 m/minute. This process may bring the base layer to desired characteristics.

In box 310, the method may include printing a pattern on top of a pre-prepared board. The pattern may be printed using, for example, an inkjet printer (e.g., printing unit 122). The pattern may be printed at a resolution of at least 180 dpi, for example, 240 dpi, 360 dpi, etc. The pattern layer may be printed using two or more pigments according to a predetermined desired design. In some embodiments, the pattern may include at least two or more different colors. In some embodiments, the pattern may be printed using only one color (e.g., black) printed on the base layer (e.g., a white based layer) to form, for example, a black and white pattern and a resolution of at least 180 dpi.

The pattern to be printed on the synthetic board may be received from a digital image file (e.g., having TIF, JPG, or any other suitable digital image formats). In some embodiments, the method may further include selecting any pattern to be printed on the board. The pattern may be selected from any desirable database. A user may select any pattern from a collection or gallery of patterns stored in database associated with system 100. Alternatively, a user (e.g., a client, an operator of system 100, or the like) may select a pattern stored in any other database, for example, images captured by the client using a camera, images uploaded by the user from internet databases, images created for the client by a professional (e.g., by an interior designer) or the like.

In box 320, the method may include curing the pattern layer. The pattern may be cured by UV radiation, using for example, curing unit 124. As used herein curing may include crosslinking of polymeric chains to stabilize and harden the polymer.

In box 330, the method may include applying a transparent protective coating layer on top of the cured pattern layer. The transparent protective coating layer may be applied by spraying, smearing, or the like, a lacquer, for example, a lacquer based on urethane acrylate resin, using, for example, coating unit 132. The thickness of the transparent protective coating layer may be no more than 150 μm. In some embodiments, the thickness of the transparent protective coating layer may be no more than 75 μm. The transparent protective coating layer may have an environmental protection level required according to ASTM G-154, when the transparent protective coating layer is exposed to 2500 hours of QUV-B radiation by accelerated weathering machine. In box 340, the method may include curing the transparent protective coating layer, by UV radiation using for example, curing system 134.

In box 350, the method may include applying an additional transparent protective coating layer on top of already cured protective coating layer. The additional protective coating layer may be applied by spraying, smearing, or the like, a lacquer using for example, coating units 132 or 142. The lacquer of the additional transparent protective coating layer may be the same or may be different from the lacquer of the already cured protective coating. In some embodiments, the thickness of the additional transparent protective coating layer may be no more than 75 μm. In box 360, the method may include curing the second transparent protective coating layer by UV radiation using for example, curing systems 134 or 144. In some embodiments, the method may include applying more than two (e.g., three, four or more) coating layers and curing each of the coated layers prior to the application of an additional coating layer.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of coating synthetic boards, comprising:
printing a pattern on top of a pre-prepared board;
curing the pattern;
applying a transparent protective coating on top of the cured pattern, wherein the thickness of the transparent protective coating is less than 500 microns; and
curing the transparent protective coating.

2. A method according to claim 1, wherein printing the pattern is by ink-jet printing.

3. A method according to claim 1 or 2, wherein the pattern is printed at a resolution of at least 180 dpi.

4. A method according to any one of the preceding claims, wherein the pattern to be printed on the board is received from a digital image file.

5. A method according to any one of the preceding claims, wherein the pattern includes at least two different colors.

6. A method according to any one of the preceding claims, further comprising selecting any pattern to be printed on the board.

7. A method according to any one of the preceding claims, further comprising selecting a pattern to be printed on the board, the pattern is selected from any desirable pattern database.

8. A method according to any one of the preceding claims, wherein the transparent protective coating has thickness of less than 500 microns.

9. A method according to claim 8, wherein the protective coating is for protecting from harmful UV radiation coming from the sun measured by a xenon machine during 1000 hours according to ISO 4892-2.

10. A method according to any one of the preceding claims, wherein applying the transparent protective coating and curing the transparent protective coating includes:
applying a first transparent protective coating layer from a first material on top of the cured pattern, wherein the thickness of the first transparent protective coating layer is less than 250 microns;
curing the first transparent protective coating layer;
applying a second transparent protective coating layer from a second material on top of the first transparent protective coating layer,
wherein the thickness of the second transparent protective coating layer is less than 250 microns; and
curing the second transparent protective coating layer.

11. A method according to claim 10, wherein the first material is the substantially the same as the second material.

12. A method according to any one of the preceding claims, wherein the pre-prepared board comprises a synthetic board coated with a cured base layer.

13. A method according to claim 12, wherein the base layer comprises a cured primer.

14. A method according to claim 12, wherein the base layer further comprises a cured white base color.

15. A method according to any one of the preceding claims, wherein curing is by exposure to ultraviolet (UV) light.

16. A method according to any one of the preceding claims, wherein the synthetic board is at least one of: PVC board, polypropylene board, polyethylene board and a wood polymer composite (WPC) board.

17. A synthetic printed board, comprising:
a synthetic board;
a printed pattern, printed directly on the synthetic board having a printed resolution of at least 180 dpi; and
a transparent protective coating.

18. A synthetic printed board according to claim 17, wherein the synthetic board is coated with a white layer.

19. A synthetic printed board according to claim 17 or claim 18, wherein the synthetic board is coated with a primer layer.

20. A synthetic printed board according to any one of claims 17-19, wherein the pattern includes at least two different colors.

21. A synthetic printed board according to any one of claims 17-20, wherein the transparent protective coating has thickness of less than 500 microns.

22. A synthetic printed board according to any one of claims 17-21, wherein the protective coating is for protecting from harmful UV radiation coming from the sun measured by xenon machine during 1000 hours according to ISO 4892-2.

23. A synthetic printed board according to any one of claims 17-22, wherein the protective coating comprises a first protective coating layer and a second protective coating layer.

24. A synthetic printed board according to any one of claims 17-23, wherein the pattern is selectable by a client.
